(19) United States
(12) Patent Application Publication
(10) Pub. No.: US 2008/0242241 A1
(43) Pub. Date: Oct. 2, 2008

(54) Wireless communications systems, remote communications systems, external device circuits, wireless device communications modification methods, and wireless communications device communications methods

(75) Inventor: John R. Tuttle, Boulder, CO (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Micron Technology, Inc.

(21) Appl. No.: 11/728,475

(22) Filed: Mar. 26, 2007

(51) Int. Cl. H04B 7/00

(52) U.S. Cl. 455/90.1

(57) ABSTRACT

Some embodiments include wireless communications systems, remote communications systems, external device circuits, wireless device communications modification methods, and wireless communications device communications methods. In one embodiment, a wireless communications system includes a reader configured to output first wireless signals and to receive second wireless signals, a wireless communications device configured to receive the first wireless signals and to output the second wireless signals, wherein the first wireless signals and the second wireless signals individually include first baseband signals, and wherein the reader and the wireless communications device are individually configured to use respective ones of the first baseband signals to form respective ones of the first wireless signals and the second wireless signals, and an external circuit device electrically coupled via an electrical connection with electrical circuitry of the wireless communications device, and wherein the external circuit device is configured to communicate second baseband signals with the wireless communications device via the electrical connection.

### TECHNICAL FIELD

The technical field includes wireless communications systems, remote communications systems, external device circuits, wireless device communications modification methods, and wireless communications device communications methods.

### BACKGROUND

Wireless communications systems which include a plurality of communications devices are useful in various systems and applications. For example, wireless communications systems may be used in applications where identification of objects is desired. A respective wireless communications system may include a base device which communicates with one or more tags which may be associated with one or more objects to be identified.

In some communication system arrangements, the number of tags used may be significant if there are numerous objects to be monitored. Furthermore, some tags may be considered to be expendable in some implementations. Accordingly, some tag arrangements may include relatively inexpensive devices which may have fixed useful lives and may be intended to be disposable in some applications. Some relatively inexpensive tag configurations may have limited capabilities. For example, the tag configurations may communicate with a reader but offer little, if any, additional functionality.

### BRIEF DESCRIPTION OF THE DRAWINGS

FIG. 1 is a functional block diagram of a wireless communications system according to one embodiment of the invention.

FIG. 2 is a functional block diagram of a remote communications system according to one embodiment of the invention.

FIG. 3 is an illustrative representation of a modulation scheme according to one embodiment of the invention.

FIG. 4 is a functional block diagram of a remote communications system according to one embodiment of the invention.

FIG. 5 is a functional block diagram of a remote communications system according to one embodiment of the invention.

FIG. 6 is a functional block diagram of a remote communications system according to one embodiment of the invention.

FIG. 7 is a functional block diagram of a remote communications system according to one embodiment of the invention.

### DETAILED DESCRIPTION OF THE ILLUSTRATED EMBODIMENTS

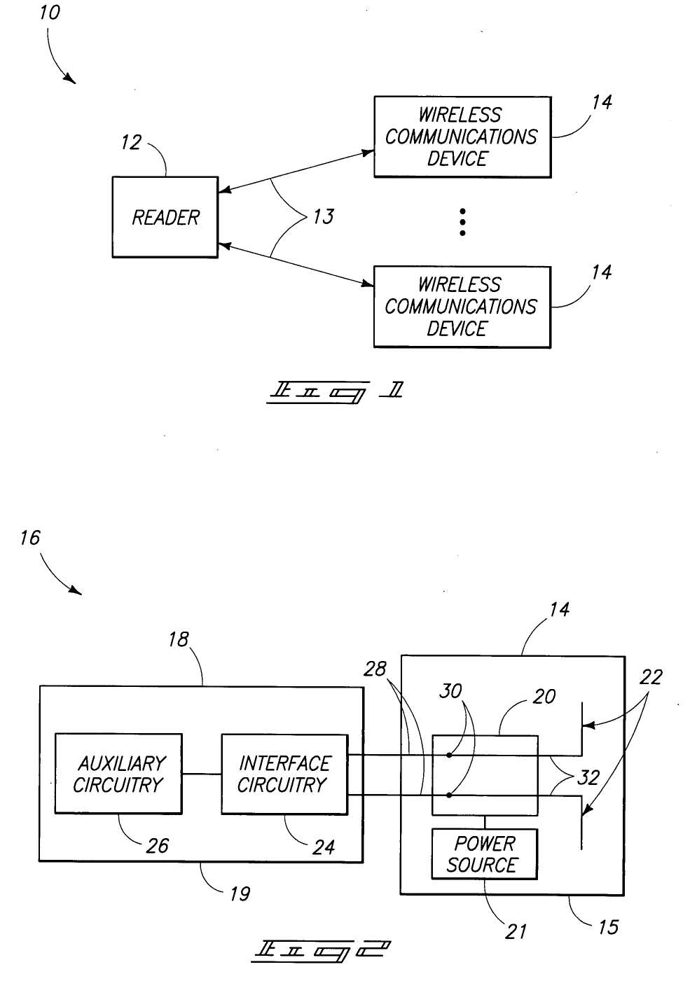

Referring to FIG. 1, a wireless communications system 10 configured in accordance with one embodiment is depicted. The system 10 includes a reader 12 configured to implement wireless communications 13 including bi-directional communications with one or more wireless communications devices 14 in one embodiment. Wireless communications devices 14 may be referred to as tags and may be associated with objects (e.g., merchandise, cargo, animals, or other articles). Wireless communications 13 may include electromagnetic signals, optical signals, or acoustic signals in some embodiments. The reader 12 and/or one or more of the wireless communications devices 14 may be portable, and accordingly, the number of wireless communications devices 14 within a communications range of reader 12 may change at different moments in time. The devices 14 may be referred to as UHF devices and communicate electromagnetic signals (e.g., microwave signals at frequencies of approximately 915 MHz or greater) in some embodiments. Accordingly, in one embodiment, wireless communications 13 may comprise substantially entirely electrical field coupling with minimal or no magnetic field coupling.

Wireless communications system 10 is configured to implement identification operations in one embodiment. The wireless communications 13 may include wireless signals comprising baseband signals having information or data to be communicated. Reader 12 may output commands which are processed by respective devices 14 and which may cause devices 14 to perform one or more desired functions. In one identification embodiment, reader 12 interrogates wireless communications devices 14 wherein the reader 12 outputs a wireless signal requesting all receiving devices 14 to respond. Wireless communications devices 14 which are present within the communications range of reader 12 receive and process the outputted signal, and the respective devices 14 may formulate replies or other messages in the form of wireless signals which may include respective identifiers which uniquely identify respective ones of the wireless communications devices 14. In some embodiments, objects, such as inventory items, may be associated with the devices 14 and the described identification operations may operate to additionally identify the objects as well as the devices 14. Wireless communications system 10 configured to implement identification operations may be referred to as a Radio Frequency Identification (RFID) system in one embodiment. Other examples of commands which may be communicated by reader 12 include commands to read data from or write data to devices 14.

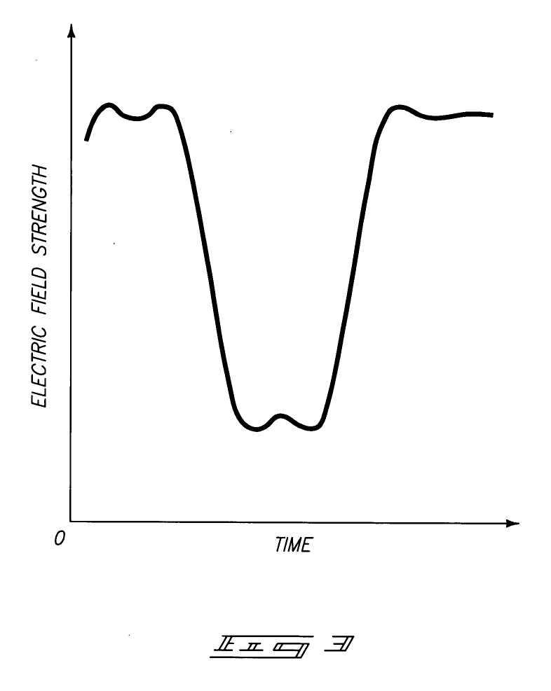

Referring to FIG. 2, an embodiment of a remote communications system 16 includes an external circuit device 18 associated with a respective wireless communications device 14. In one embodiment, external circuit device 18 may be used to add or enhance functionality and/or capabilities of wireless communications device 14. As mentioned previously, some configurations of wireless communications devices 14 may be inexpensive (e.g., having limited functionality), and the external circuit device 18 may be used to increase the functionality of the device 14. Device 18 may be considered as a retrofit to an existing device 14 in one embodiment wherein the device 18 implements communications with the device 14 in a manner corresponding to communications of reader 12 with the device 14 while also adding functionality to device 14 in addition to the pre-existing capabilities of device 14.

In one embodiment, devices 14, 18 include respective housings 15, 19 which may house and protect circuit components of the respective devices 14, 18. Housings 15, 19 may include any material suitable for wireless communications 13 and may encapsulate and protect some or all circuit components of the respective devices 14, 18 in one embodiment. Housings 15, 19 may be coupled with one another to form remote communications system 16.

In one embodiment, wireless communications device 14 includes an integrated circuit 20, a power source 21, and an antenna 22. Integrated circuit 20 may include communications circuitry, processing circuitry and/or storage circuitry in one embodiment.

One embodiment of the communications circuitry is configured to implement bi-directional communications of the wireless communications 13 with reader 12. For example, the communications circuitry may include a receiver configured to receive and demodulate wireless signals outputted from reader 12 providing baseband signals, and a transmitter configured to generate wireless signals to be communicated to reader 12. As discussed in further detail below, the communications circuitry may be configured to control an impedance of antenna 22 to implement backscatter modulation operations to send wireless signals to reader 12 in one embodiment.

In one embodiment, processing circuitry is arranged to process data, control data access and storage, issue commands, and control other desired operations. The processing circuitry of the integrated circuit 20 may process baseband signals demodulated from wireless signals received from reader 12. In one embodiment, the processing may include analyzing the signals for requests for information, implementing commands of signals, reading of sensors described below, or performing other functions with respect to devices 14 and/or 18. Processing circuitry may comprise circuitry configured to implement desired programming provided by appropriate media in at least one embodiment. The processing circuitry may be implemented as one or more of a processor and/or other structure configured to execute executable instructions including, software and/or firmware instructions, and/or hardware circuitry. Some embodiments of processing circuitry include hardware logic, PGA, FPGA, ASIC, state machines, and/or other structures alone or in combination with a processor. These embodiments of processing circuitry are non-limiting and for illustration only and other configurations may be used in other embodiments.

The storage circuitry is configured to store programming such as executable code or instructions (e.g., software and/or firmware), electronic data, databases, or other digital information (e.g., a unique identification number to identify the respective device 14) and may include processor-usable media. Processor-usable media may be embodied in any computer program product(s) or article of manufacture(s) which can contain, store, or maintain programming, data and/or digital information for use by or in connection with an instruction execution system including processing circuitry in one embodiment. Processor-usable media may include any one of physical media such as electronic, magnetic, optical, electromagnetic, infrared or semiconductor media. Some embodiments of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information. Other configurations including one or more of communications circuitry, processing circuitry and/or storage circuitry apart from integrated circuit 20 may be used in other embodiments.

Power source 21 is configured to provide operational electrical energy to device 14. Power source 21 may be configured as a battery to provide the operational electrical energy (e.g., in active or semi-passive embodiments) and/or circuitry configured to provide operational electrical energy using electromagnetic energy received at the device 14 (e.g., in passive embodiments). In one embodiment, power source 21 may be configured to extract energy, for example by diode rectification circuitry, from incident RF power such as from an electromagnetic field of wireless communications 13 emanating from reader 12 and/or from other wireless sources. As discussed below, external circuit device 18, which also includes a power source in one embodiment, may be used to enhance functionality of wireless communications device 14 and power source 21 (if present) may be used to supply operational electrical energy to wireless communications device 14 when device 18 is associated with device 14.

Antenna 22 is configured as a dipole antenna in one embodiment. Antenna 22 is configured to receive electromagnetic energy and may formulate electrical signals corresponding to wireless signals received from reader 12 in one embodiment. Antenna 22 is configured to implement outputting of wireless signals to be communicated to reader 12 in one embodiment. In one embodiment, respective halves of antenna 22 may be selectively shorted together and insulated from one another to change the impedance of antenna 22 and to implement backscatter modulation of electromagnetic energy which may be present at device 14. In one backscatter embodiment, reader 12 may selectively output a continuous wave of electromagnetic energy which is modulated by device 14. In another embodiment, antenna 22 may emit electromagnetic energy to transmit wireless signals to reader 12.

Plural leads 32 of antenna 22 are connected to electrical connections 30 of integrated circuit 20. In one embodiment, electrical connections 30 may include bond pads, lands, or other electrical conductors which provide electrical connection of antenna 22 and integrated circuit 20.

In one embodiment, external circuit device 18 includes interface circuitry 24 coupled with auxiliary circuitry 26. Interface circuitry 24 is configured to connect to wireless communications device 14. In one embodiment, interface circuitry 24 may connect with wireless communications device 14 via one or more electrical connection 28. Interface circuitry 24 operates to receive signals from device 14 and/or to output signals to device 14. Signals communicated by interface circuitry 24 may include electrical signals in one embodiment.

Auxiliary circuitry 26 is coupled with interface circuitry 24 and may process signals received from wireless communications device 14 and/or may formulate signals to be communicated to device 14. In one embodiment, the auxiliary circuitry 26 may include a sensor (not shown in FIG. 2) configured to perform operations such as sensing an environment or condition of device 14 and generating signals responsive to the sensing.

In one embodiment, auxiliary circuitry 26 may include control circuitry configured to control an operation of external circuit device 18 or other device (not shown) which may be connected to external circuit device 18. In one embodiment, the auxiliary circuitry 26 may include a power source (not shown in FIG. 2) configured to provide operational electrical energy to external circuit device 18 and/or wireless communications device 14. Additional configurations of auxiliary circuitry 26 configured to add additional functionality to device 14 are contemplated for implementation in other embodiments.

In one embodiment, electrical connections 28 connect interface circuitry 24 with circuitry of wireless communications device 14 and communicate electrical signals intermediate devices 14, 18. Other types of connections and/or signals may be used to implement communications, between devices 14, 18 in other embodiments. In one embodiment, the electrical connections 28 are coupled with leads 32 of antenna 22 and with connections 30 of integrated circuit 20. In one embodiment, the electrical signals communicated using electrical connections 28 correspond to a type of baseband signals of wireless communications 13 as described further below.

In one embodiment, external circuit device 18 may be associated with a wireless communication device 14 to increase the functionality of device 14, and as mentioned above, device 18 may be considered to retrofit or as a modification to device 14. In one embodiment, electrical connections 28 may be electrically connected directly with electrical connections 30 and/or leads 32 if a portion of connections 30 and/or leads 32 are outwardly exposed (e.g., exposed outside of housing 15). In another embodiment, connections 30 and leads 32 are electrically insulated from an exterior of the device 14 at an initial moment of time, and thereafter a portion of housing 15 may be removed to outwardly expose connections 30 and/or leads 32 for connection with electrical connections 28. Other configurations are possible to connect devices 14, 18.

In one embodiment, wireless communications device 14 is configured to communicate using baseband signals. Baseband signals may comprise data received from reader 12 and/or data to be communicated to reader 12. Some baseband signals may be generated by integrated circuit 20 and used to modulate electromagnetic energy or to modulate carrier signals to form wireless signals outputted by device 14 (e.g., backscatter signals or transmitted signals) to communicate respective data to reader 12. Additional baseband signals may correspond to demodulated signals of wireless signals received by device 14 and may include data communicated by reader 12 in one embodiment.

As discussed herein according to one embodiment, external circuit device 18 may be added to an existing wireless communications device 14 to add functionality and/or expand or enhance the capabilities of the device 14. In one embodiment, external circuit device 18 may communicate with wireless communications device 14 using electrical signals which may comprise baseband signals and which have a modulation scheme corresponding to the baseband signals of the wireless communications 13 with reader 12.

One embodiment of a baseband signal communicated using electrical connection 28 or communicated using wireless communications 13 (either received by or outputted from wireless communications device 14) is shown in FIG. 3. The depicted signal utilizes an amplitude-shift keying (ASK) modulation scheme to distinguish digital zeros and ones (e.g., using Miller or FM0 modulation schemes in one embodiment). Other data modulation schemes of baseband signals are possible. Demodulation of wireless signals received from reader 12 is performed by device 14 to remove a radio frequency carrier (e.g., the RF carrier of wireless communications 13 is not shown in FIG. 3) resulting in the ASK baseband signal in one embodiment. An ASK baseband signal may be used to modulate a continuous wave radio frequency signal present at device 14 to output wireless signals from device 14 in one embodiment.

Furthermore, electrical signals in the form of baseband signals may be communicated intermediate devices 14, 18 using one or more electrical connections 28 in one embodiment. Communications circuitry of device 18 (e.g., interface circuitry 24 in one embodiment) may implement the communications with device 14. As mentioned previously, external circuit device 18 may be used to add functionality, enhance and/or to increase the capabilities of device 14. In one embodiment, the electrical signals communicated using electrical connections 28 may comprise baseband signals having a modulation scheme corresponding to the modulation schemes of baseband signals of the wireless communications 13 to facilitate processing of the electrical signals by integrated circuit 20 which is already configured to communicate with reader 12. The electrical signals for communications intermediate devices 14, 18 (i.e., baseband signals) provide a modulation envelope corresponding to the wireless communications 13 without a radio frequency carrier. External circuit device 18 may monitor wireless communications 13 occurring intermediate reader 12 and the respective device 14 via the baseband signals as well as implement transmit and receive communications with respect to the device 14 (and the reader 12 using the communications circuitry of device 14) using baseband signals in one embodiment.

In one embodiment, communications circuitry of external circuit device 18 is configured to emulate operations of reader 12 and bi-directional wireless communications 13 intermediate devices 12, 14. The communications circuitry of external circuit device 18 may communicate different communications than those occurring in wireless communications 13 and/or some or all of the same communications which may occur intermediate devices 12, 14 via wireless communications 13. For example, the communications intermediate external circuitry device 18 and wireless communications device 14 may include signals generated and communicated by device 18 to implement one or more operations within device 14 (e.g., and which may or may not be implemented in device 14 responsive to communications from reader 12). For example, device 18 may generate the communications to provide power to device 14, to indicate commands to be performed by device 14, read/write data with respect to device 14 and/or perform other operations absent wireless communications 13 intermediate devices 14, 18. In one embodiment, device 18 is configured to implement a command set with respect to device 14 which may correspond to a command set of reader 12 as well as respond to commands from one or both of reader 12 and device 14.

In one embodiment of system 10, external circuit device 18 may communicate, in the absence of wireless communications 13 from reader 12, appropriate signals (e.g., base band signals, signals representing or emulating an envelope of the carrier from reader 12, or other signals) to device 14. For example, transmissions which are typically provided by reader 12 (e.g., transmissions to charge power source 21, including cues, including commands, or reading/writing data, etc.) may be transmitted by device 18 at some moments in time in the absence of wireless communications 13. Wireless communications 13 may occur at other moments in time between devices 12, 14 per typical operations.

In addition, communications may also occur between reader 12 and external circuitry device 18 via antenna 22 in one embodiment. In some embodiments, some or all of the communications intermediate reader 12 and device 18 may be recognized by wireless communications device 14 while in other embodiments, the communications intermediate reader 12 and device 18 are not recognizable by wireless communications device 14 (e.g., comprising commands outside of a command set recognizable by device 14). Accordingly, in illustrative embodiments, additional functions, commands and/or responses may be enabled in remote communications system 16 beyond those implemented by wireless communications device 14. For example, if external circuitry device 18 includes a temperature sensor, reader 12 may read temperature from device 18 via appropriate commands with or without usage of circuitry of device 14. In another example wherein device 18 includes a switch, reader 12 may communicate appropriate commands to change a state of switch with or without usage of circuitry of device 14. Other examples of communications between reader and device 18 are possible.

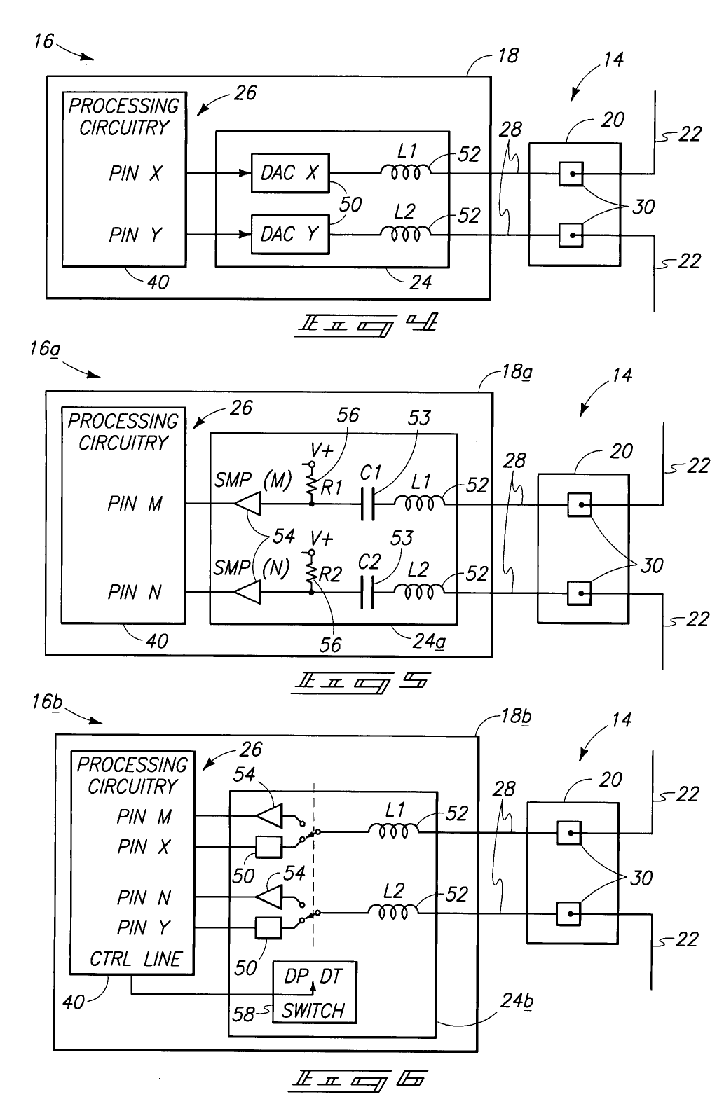

Referring to FIG. 4, one embodiment of remote communications system 16 is shown. Operations of communicating electrical signals from external circuit device 18 to wireless communication device 14 are shown. The interface circuitry 24 of the system 16 includes plural digital-to-analog converters 50 and isolation circuitry in the form of plural inductors 52 in the depicted embodiment coupled with electrical connections 28. Other configurations of isolation circuitry are contemplated and may include component networks in one embodiment. Converters 50 may be controlled by processing circuitry 26 in one embodiment.

Converters 50 output analog signals corresponding to digital output generated at respective output pins x, y of processing circuitry 40 which may be configured similarly to the above-described processing circuitry of integrated circuit 20 in one embodiment. Converters 50 operate to reduce an amplitude of digital voltage swings down to relatively small voltage differentials (e.g., microVolts) that wireless communications device 14 expects to observe at connections 30 corresponding to an envelope from reader 12. In one embodiment, inductors 52 are configured to pass baseband signals for communication to integrated circuit 20. Inductors 52 may be further configured to block electrical signals having frequencies close to frequencies of radio frequency signals of the wireless communications 13 from passage into circuitry of device 18 and which may interfere with circuitry of device 18. Inductors 52 provide a high impedance to incoming radio frequency energy from reader 12 but a low impedance for baseband signals enabling such signals to pass. Also, when not in use, the input impedance of converters 52 may be high to avoid interaction with incoming baseband signals corresponding to wireless communications 13. Electrical signals received by device 14 from device 18 may be processed by integrated circuit 20 as corresponding to baseband communications from reader 12 in one embodiment.

Referring to FIG. 5, one embodiment of remote communications system 16a is shown with respect to communications of signals from wireless communications device 14 to external circuit device 18a. Electrical connections 28 are coupled with inductors 52, capacitors 53, amplifiers 54 and resistors 56 of interface circuitry 24a. Capacitors 53 block DC voltage which may be present at connections 30 of integrated circuit 20. Amplifiers 54 enable processing circuitry 40 to read the electrical signals received at respective pins m, n. Resistors 56 may be used to generate voltage inputs to amplifiers 54 upon changes of state of baseband signals received from device 14 which reduces the gain provided by amplifiers 54.

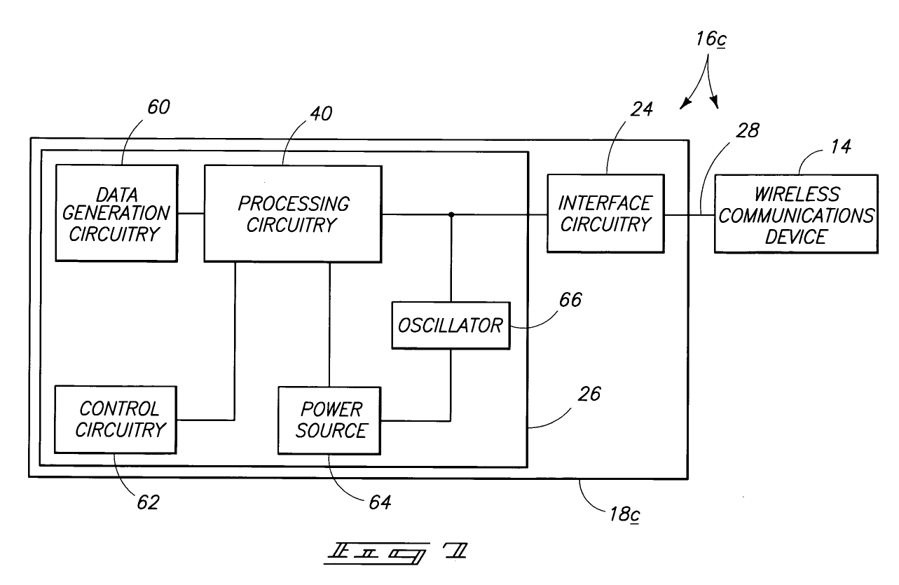

Referring to FIG. 6, one embodiment of remote communication system 16b is shown with respect to bi-directional communications of signals intermediate wireless communications device 14 and external circuit device 18b. A control line (CTRL LINE) of processing circuitry 40 is used to control a double-pole double-throw switch 58 of interface circuitry 24b configured to selectively connect input pins m, n or output pins x, y with electrical connections 28 during receive or transmit operations of external circuit device 18.

Referring to FIG. 7, details of one embodiment of external circuit device 18c are shown. Auxiliary circuitry 26 additionally includes data generation circuitry 60, control circuitry 62 and a power source 64 in one embodiment. As discussed below in various embodiments, external circuit device 18c expands the capabilities of device 14 to include monitoring, control and/or increase of power capacity.

Data generation circuitry 60 is configured to generate data which may be communicated in one embodiment. For example, data generation circuitry 60 may include a sensor configured to perform sensing operations such as sensing an environment about device 18c and/or sensing a condition present at device 18c in one embodiment. For example, the sensor may be configured to sense temperature of an environment about device 18c or sense a state of a condition (on/off) of equipment (not shown). Processing circuitry 40 may access the data generated by circuitry 60 (e.g., regarding the environment or condition) and formulate baseband signals comprising the data for communication to interface circuitry 24 and wireless communications device 14. Device 14 may process, store and/or communicate the data of the baseband signals to reader 12 using wireless communications 13.

Processing circuitry 40 is coupled with control circuitry 62 and processing circuitry 40 may operate to issue commands to control the control circuitry 62. Control circuitry 62 may control or change an operation of device 18c or equipment (not shown) coupled with device 18c in one embodiment. Commands may be internally generated by processing circuitry 40, issued by wireless communications device 14 and/or issued by reader 12 in some embodiments.

Power source 64 may be configured to supply operational electrical energy to wireless communications device 14 and/or external circuit device 18c. The operational electrical energy generated by the power source 64 may be the sole supply of energy to device 14 or may be used to supplement operational electrical energy provided by device 14. In one embodiment, power source 64 is configured as a battery which may be replaceable. Operational electrical energy may be provided from power source 64 via electrical connection 28 to device 14. In one embodiment, an oscillator 66 may be coupled with the power source 64 to provide periodic operational electrical energy (e.g., square wave) having a frequency different than a frequency of baseband signals communicated using electrical connection 28 to avoid interference with the baseband signals (e.g., frequency difference of a factor four or more). If wireless communications device 14 is configured as a passive device (i.e., wherein transmit and receive operations of the device 14 derive operational electrical energy from received electromagnetic energy), coupling of device 18c with device 14 may be considered to covert device 14 to a semi-passive device 14 wherein receive circuitry of device 14 receives electrical energy from a power source 64. In one embodiment, wireless communications device 14 may be an EPC Global Class 1, Gen 2 device (e.g., passive) which has been enhanced by external circuit device 18c to become a Class 3 device in the form of a semi-passive device including an integral power source and integrated sensing circuitry. Wireless communications device 14 may also be an active device wherein transmit and receive operations of the device 14 are battery powered.

Power source 64 may be used in one embodiment as a booster to device 14 configured as a passive device for the purpose of increasing a communications range of the device 14. In general, a range of a passive device 14 may be limited by a relatively small amount of ambient radio frequency power presented to an antenna of reader 12. Providing operational electrical energy using device 18c to the wireless communications device 14 increases the read range of device 14 by reader 12 in one embodiment. Processing circuitry 40 may implement power management operations to turn the power source 64 on during communications of device 14 and to otherwise conserve power from power source 64. In embodiments of device 18c not including processing circuitry 40, a separate power management circuit (not shown) may be used to implement power conservation operations.

In compliance with the statute, the subject matter disclosed herein has been described in language more or less specific as to structural and methodical features. It is to be understood, however, that the claims are not limited to the specific features shown and described, since the means herein disclosed comprise only some of the various contemplated embodiments. The claims are thus to be afforded full scope as literally worded, and to be appropriately interpreted in accordance with the doctrine of equivalents.

Further, details herein have been presented for guidance in construction and/or operation of the disclosed embodiments. Applicant(s) hereof consider these described embodiments to also include, disclose and describe further arrangements or embodiments in addition to those explicitly disclosed. For example, the additional embodiments may include less, more and/or alternative features than those described in the specifically described embodiments. More specifically, Applicants consider the disclosure to include, disclose and describe methods which include less, more and/or alternative acts than those methods explicitly disclosed as well as apparatus which includes less, more and/or alternative structure than the explicitly disclosed structures.

1. A wireless communications system comprising:
a reader configured to output first wireless signals and to receive second wireless signals;
a wireless communications device configured to receive the first wireless signals and to output the second wireless signals;
wherein the first wireless signals and the second wireless signals individually include first baseband signals, and wherein the reader and the wireless communications device are individually configured to use respective ones of the first baseband signals to form respective ones of the first wireless signals and the second wireless signals; and
an external circuit device electrically coupled via an electrical connection with electrical circuitry of the wireless communications device, and wherein the external circuit device is configured to communicate second baseband signals with the wireless communications device via the electrical connection.

2. The system of claim 1 wherein the first baseband signals comprise signals of a common modulation scheme configured to form the first and second wireless signals and wherein the second baseband signals comprise signals of the common modulation scheme.

3. The system of claim 1 wherein the external circuit device comprises a sensor configured to generate data responsive to sensing operations.

4. The system of claim 3 wherein the data is to be communicated from the external circuit device to the wireless communications device using the second baseband signals, and the wireless communications device is configured to communicate the data to the reader using the second wireless signals.

5. The system of claim 1 wherein the wireless communications device comprises a first power source configured to provide first operational electrical energy to the electrical circuitry of the wireless communications device, and wherein the external circuit device comprises a second power source configured to provide second operational electrical energy to the electrical circuitry of the wireless communications device.

6. The system of claim 5 wherein the first power source is configured to provide the first operational electrical energy using electromagnetic energy present at the wireless communications device, and the second power source comprises a battery configured to provide the second operational electrical energy.

7. The system of claim 6 wherein the electrical circuit device is configured to provide the second operational electrical energy to the electrical circuitry at a frequency different than a frequency of the second baseband signals.

8. The system of claim 1 wherein the wireless communications device is configured to output the second wireless signals using backscatter modulation of electromagnetic energy present at the wireless communications device.

9. The system of claim 1 wherein the reader is configured to output electromagnetic energy and the wireless communications device is configured to output the second wireless signals using backscatter modulation of the electromagnetic energy.

10. The system of claim 1 wherein the wireless communications device is configured to output at least one of the second wireless signals comprising an identifier configured to uniquely identify the wireless communications device.

11. The system of claim 1 wherein the wireless communications device comprises a first housing configured to house circuitry of the wireless communications device, and the external circuit device comprises a second housing configured to house circuitry of the external circuit device.

12. The system of claim 1 wherein the external circuit device comprises isolation circuitry coupled with the electrical connection and configured to isolate circuitry of the external circuit device from electrical signals of the electrical connection having frequencies of the first and second wireless signals.

13. The system of claim 1 wherein the external circuit device is electrically connected to a lead of an antenna of the wireless communications device.

14. The system of claim 1 wherein the reader and the wireless communications device are configured to communicate the first and second wireless signals via electrical field coupling of the reader and the wireless communications device and substantially void of magnetic field coupling.

15. The system of claim 1 wherein the reader and the wireless communications device are configured to communicate the first and second wireless signals comprising microwave signals.

16. The system of claim 1 wherein the external circuit device is configured to generate the second baseband signals corresponding to the first baseband signals.

17. The system of claim 16 wherein the reader is configured to generate the first baseband signals to implement a plurality of operations within the wireless communications device, and the external circuit device is configured to generate the second baseband signals corresponding to the first baseband signals to implement at least some of the operations within the wireless communications device.

18. The system of claim 16 wherein the external circuit device is configured to generate the second baseband signals during an absence of the first wireless signals.

19. The system of claim 1 wherein at least one of the reader and the wireless communications device is configured to generate respective ones of the first and second baseband signals to implement communications with respect to the other of the reader and the wireless communications device.

20. The system of claim 19 wherein the generated first and second baseband signals are not recognized by the wireless communications device.

21. A remote communications system comprising:
a wireless communications device comprising:
a housing;
an antenna coupled with the housing of the wireless communications device;
communications circuitry coupled with the antenna and configured to receive first wireless signals from a reader and to output second wireless signals to be communicated to the reader and which are configured to uniquely identify the wireless communications device; and
a circuit device external of the wireless communications device and comprising:
a housing; and
auxiliary circuitry coupled with the housing of the circuit device and electrically connected to the wireless communications device and configured to communicate electrical signals comprising data to be communicated with respect to the wireless communications device.

22-28. (canceled)

29. A wireless communications system comprising:
a wireless communications device comprising:
communications circuitry configured to implement wireless communications with respect to a reader; and
a power source configured to provide operational electrical energy to the communications circuitry;
an electrical connection electrically connected to the wireless communications device; and
a circuit device external of the wireless communications device and comprising:
a power source configured to provide additional operational electrical energy to the wireless communications device using the electrical connection.

30-33. (canceled)

34. A circuit device comprising:
an electrical connection configured to electrically couple with a wireless communications device which is configured to implement wireless modulation operations to communicate first baseband signals externally of the wireless communications device to a reader; and
processing circuitry coupled with the electrical connection and configured to control the generation of second baseband signals and the communication of the second baseband signals via the electrical connection to the wireless communications device, wherein the second baseband signals have a modulation scheme common to a modulation scheme of the first baseband signals communicated using the wireless communications device to the reader.

35-40. (canceled)

41. A wireless communications device modification method comprising:
providing a wireless communications device configured to wirelessly communicate with a reader using electromagnetic communications, wherein an electrical connection of the wireless communications device is exposed outwardly of the wireless communications device;
providing an external circuit device configured to at least one of output and receive baseband signals having a modulation scheme of baseband signals of the wireless communications of the wireless communications device; and
connecting an electrical connection of an external circuit device with the outwardly exposed electrical connection of the wireless communications device.

42. The method of claim 41 further comprising communicating with the reader using the wireless communications device without connection of the external circuit device with the wireless communications device.

43. The method of claim 41 wherein the providing the external circuit device comprises providing the external circuit device comprising a power source configured to provide operational electrical energy to the wireless communications device using the electrical connection.

44. The method of claim 43 wherein the providing the wireless communications device comprises providing the wireless communications device comprising a power source.

45. The method of claim 44 wherein the providing the external circuit device comprises providing the external circuit device comprising the power source comprising a battery, and the providing the wireless communications device comprises providing the wireless communications device comprising the power source configured to provide operational electrical energy to the wireless communications device using electromagnetic energy present at the wireless communications device

46. The method of claim 41 wherein the providing the wireless communications device comprises providing the wireless communications device configured to output a wireless signal comprising an identifier configured to uniquely identify the wireless communications device.

47. The method of claim 41 wherein the providing the external circuit device comprises providing the external circuit device comprising isolation circuitry coupled with the electrical connection of the external circuit device and configured to isolate circuitry of the external circuit device from electrical signals having frequencies of the electromagnetic communications of the wireless communications device.

48. The method of claim 41 wherein the providing the wireless communications device comprises providing the wireless communications device having the outwardly exposed electrical connection connected to a lead of an antenna of the wireless communications device.

49. The method of claim 41 wherein the providing the external circuit device comprises providing the external circuit device comprising a sensor configured to generate data responsive to sense operations.

50. The method of claim 41 wherein the providing the wireless communications device comprises:
providing the wireless communications device in a configuration wherein the electrical connection of the wireless communications device is electrically insulated from an exterior of the wireless communications device; and
outwardly exposing the electrical connection after the providing the wireless communications device, and wherein the connecting comprises connecting after the outwardly exposing.

51. A wireless communications device communications method comprising:
using a wireless communications device, receiving a wireless signal outputted by a reader;
using the wireless communications device, demodulating the wireless signal providing a first baseband signal;
processing the first baseband signal using processing circuitry of the wireless communications device;
generating a second baseband signal using an external circuit device comprising a device external of the wireless communications device; and
communicating the second baseband signal comprising an electrical signal from the external circuit device to the wireless communications device via an electrical connection intermediate the external circuit device and the wireless communications device.

52-58. (canceled)

59. A wireless communications device communications method comprising:
electrically connecting an external circuit device with a wireless communications device using an electrical connection, wherein the wireless communications device is configured to generate operational electrical energy using electromagnetic energy received by the wireless communications device;
using the external circuit device, providing additional operational electrical energy to the wireless communications device using the electrical connection; and
using the wireless communications device, communicating wireless signals using at least one of the operational electrical energy generated by the wireless communications device and the additional operational electrical energy provided by the external circuit device.

60-64. (canceled)
